(19) United States
(12) Patent Application Publication
(10) Pub. No.: US 2006/0226977 A1
(43) Pub. Date: Oct. 12, 2006

(54) Method and apparatus for providing information to a user of a security system

(76) Inventors: Paul DeLozier, Walworth, NY (US); Steven A. Markham, Rochester, NY (US); Dennis M. Caler, Marion, NY (US)

Correspondence Address: BAKER & DANIELS LLP;111 E. WAYNE STREET, SUITE 800, FORT WAYNE, IN, 46802, US

(21) Appl. No.: 11/103,155

(22) Filed: Apr. 11, 2005

(51) Int. Cl. G08B 13/00

(52) U.S. Cl. 340/541

(57) ABSTRACT

A method of operating a security system includes detecting a presence of a person in proximity to a user interface. The user interface is caused to generate audible messages dependent upon the detection of the presence of a person in proximity to the user interface.

### BACKGROUND OF THE INVENTION

1. Field of the Invention

The present invention relates to surveillance systems including user interfaces, and, more particularly, to surveillance systems including user interfaces that communicate information to a user.

2. Description of the Related Art

Surveillance systems, also known as security systems, are known to include security sensors, such as motion detectors, door sensors, window sensors, smoke detectors, etc., for monitoring a secured area of space. The security systems also include user interfaces for operating and controlling the security system. Operation and control concerns the activities of the installer, the end user, and, to some extent, the manufacturer.

Typical user interfaces employ a variety of channels for informing an operator of current system conditions. These channels may be either visual or audible in nature. Visual channels may include light emitting diodes (LEDs), text labels, fixed text displays, and variable text displays. Audible channels may include beeps generated by a piezo device or a speaker, and native language voice from a speaker.

A labeled LED in conjunction with a generated tone could be used to indicate various system information. Two examples of such information are the arming state and a low battery indication. When the system is set to an armed state, an LED may flash ON and OFF and a tone may sound to thereby inform the user that he should exit the premises. When the system's battery voltage falls below an acceptable level, an LED may light and a pulsed tone may alert the premises to the fact that there is a low battery.

Traditional user interfaces do not use voice as a primary channel for passing information to the user. The reluctance to use voice is mainly due to the inability of the security system to determine when the user is in proximity to the user interface to hear the message. The user interface would need to repeat the voice messages on a regular basis until the user acknowledges the message, such as by depressing a button or entering a code. A problem with this approach is that the repetition of the audible message may annoy non-users who are in hearing distance of the message. Moreover, even a system user may not wish to hear the message until he is close to the user interface and it is more convenient to address the issues of the security system.

Another possible approach is to flash an LED on the user interface when there is information to be passed along to the user. The user may depress a pushbutton or enter a code in order to hear the message. A problem with this approach, however, is that a flashing light on the user interface may not be enough to capture the user's attention. Moreover, when passing by the user interface, the user may not have a free hand with which to depress the buttons on the user interface.

What is needed in the art is a security system that is able to determine when it is appropriate to broadcast a voice message, and that thus may employ natural voice language as the primary channel for informing users of system information.

### SUMMARY OF THE INVENTION

The present invention provides a security system including a user interface that is capable of detecting the presence of a person in proximity to the user interface. The user interface may broadcast voice messages of a first type only when the user is detected in proximity to the user interface, and may broadcast voice messages of a second type, e.g., messages that are critical or important, regardless of whether the presence of the person in proximity to the user interface is detected.

The invention comprises, in one form thereof, a method of operating a security system, including detecting a presence of a person in proximity to a user interface. The user interface is caused to generate audible messages dependent upon the detection of the presence of a person in proximity to the user interface.

The invention comprises, in another form thereof, a security system including a first sensor for detecting a predefined event. A user interface includes an audio speaker and a second sensor for detecting a presence of a person in proximity to the user interface. A control device is in communication with the first sensor and the user interface. The control device issues an alarm signal in response to the first sensor detecting the predefined event. The audio speaker is caused to generate audible messages dependent upon whether the second sensor detects the presence of a person in proximity to the user interface.

The invention comprises, in yet another form thereof, a security system including an audio speaker, and a sensor for detecting a presence of a person in proximity to the audio speaker. A control device is in communication with the sensor and the audio speaker. The control device causes the audio speaker to generate audible messages of a first type. The generation of the audible messages of the first type being dependent upon whether the sensor detects the presence of a person in proximity to the audio speaker. The control device also causes the audio speaker to generate audible messages of a second type. The generation of the audible messages of the second type being independent of whether the sensor detects the presence of a person in proximity to the audio speaker.

An advantage of the present invention is that it prevents the broadcasting of repetitive voice prompts which may annoy people who are not near the user interface, or who are not users of the security system.

Another advantage is that power consumption savings may be realized due to the security system announcing information only when a user is present.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of one embodiment of a security system of the present invention.

FIG. 2 is a block diagram of one embodiment of the user interface of FIG. 1.

FIG. 3 is a side view of the user interface of FIG. 2 mounted on a wall within the building of FIG. 1.

FIG. 4 is a plan view of one embodiment of the user interface of FIG. 1.

FIG. 5 is a flow chart of one embodiment of a method of the present invention for operating the security system of FIG. 1.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DESCRIPTION OF THE PRESENT INVENTION

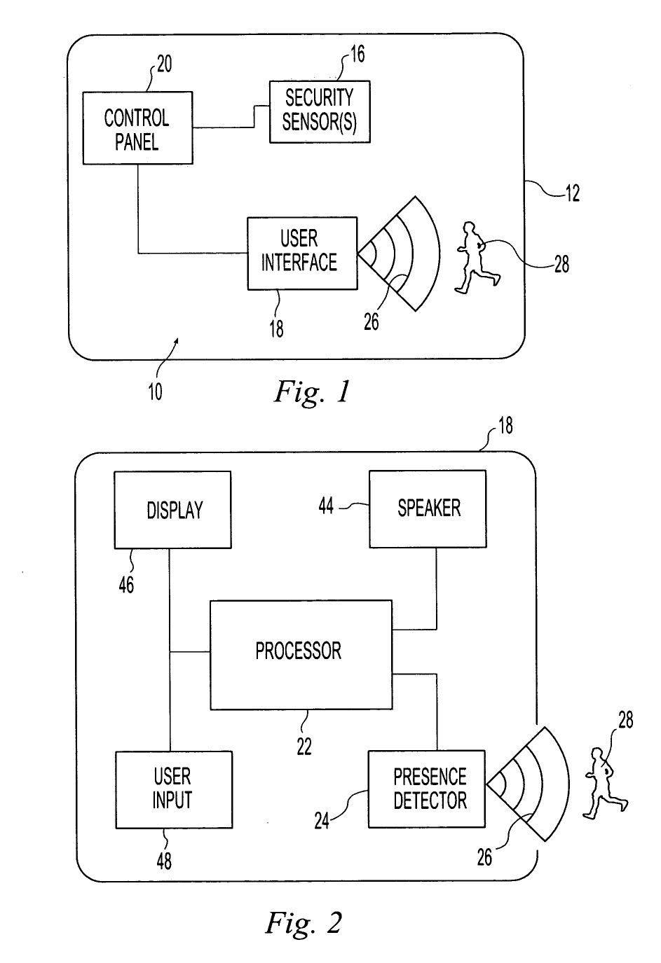

Referring now to the drawings and particularly to FIG. 1, there is shown one embodiment of a security system 10 of the present invention for a structure 12 such as a building. However, system 10 may be used to secure other spaces, such as outdoor areas, subterranean rooms and passages, and zones of air space. System 10 includes security sensor(s) 16, a user interface 18, and a control device in the form of a control panel 20.

Control panel 20 is shown as being electrically connected to sensor(s) 16 and user interface 18 via wires. However, it is also possible for control panel 20 to be in wireless communication with sensor(s) 16 and user interface 18. Control panel 20 may include a processor, a memory device and a telephone interface, none of which are shown. Control panel 20 may include software for interpreting signals from sensor(s) 16 and deciding based thereon whether to initiate an alarm signal from control panel 20. The alarm signal may be used to activate an audible alarm (not shown) within building 12, or to notify a central station receiver (CSR) (not shown) such as a security company, fire station, or police station, for example, via a public telephone network (not shown).

Sensor(s) 16 may be in the form of any number or combination of window sensors, door sensors, motion detectors, smoke detectors, panic devices, gas detectors and keyfobs, for example. Each sensor 16 may generally sense some respective predefined event. Window sensors and door sensors may detect the opening and/or closing of a corresponding window or door, respectively. Panic devices may be in the form of devices that human users keep on their person, and that are to be used to summon help in an emergency situation. Gas detectors may sense the presence of a harmful gas such as carbon monoxide, or carbon dioxide. A keyfob may be used to arm or disarm security system 10, and is another device that a user may possibly keep on his person.

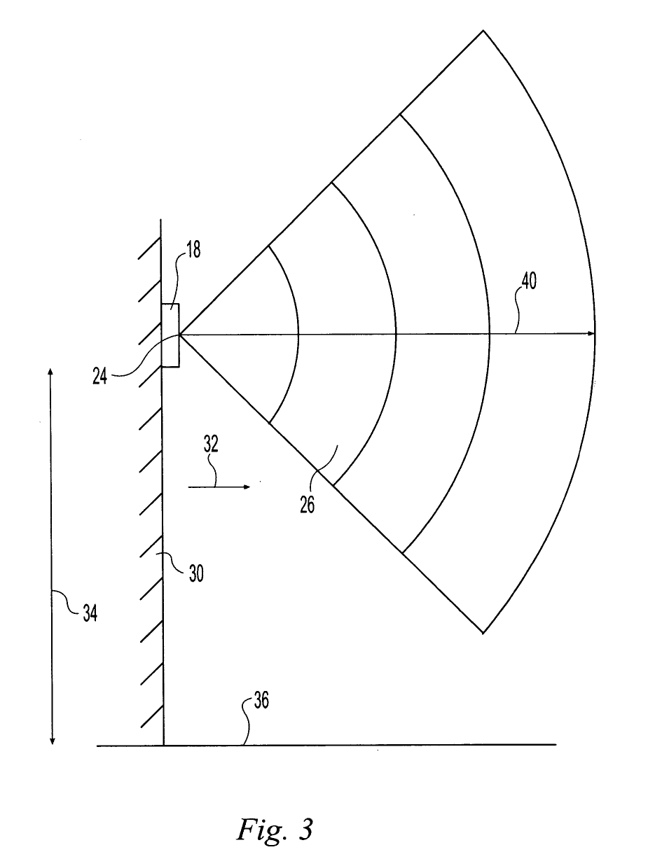

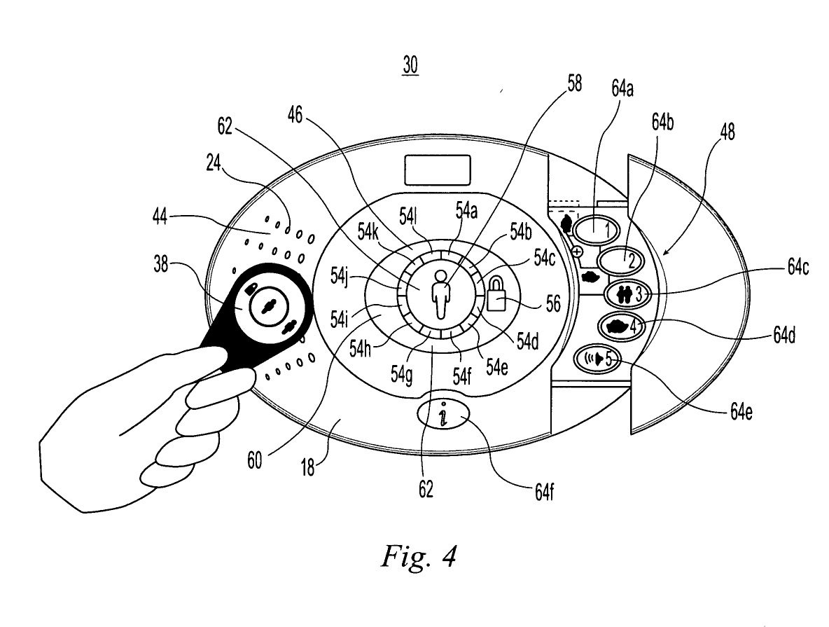

As shown in FIG. 2, user interface 18 includes a processor 22 in communication with each of a presence detector or proximity sensor 24, an audio speaker 44, a visual display such as liquid crystal diode (LCD) display 46, and a keypad 48 or some other user input that enables the user to select a mode of operation and otherwise program security system 10. Proximity sensor 24 may be in the form of a passive infrared (IR) device having a field of view 26. IR sensor 24 may detect the movement and/or presence of any warm body 28 that enters field of view 26. As shown in FIG. 3, user interface 18 may be mounted on a wall 30 within building 12. IR sensor 24 may be generally directed in a direction 32 that is perpendicular to wall 30. User interface 18 may be mounted a distance 34 of approximately five feet above a floor 36. Field of view 26 may be generally conically-shaped, or may have the shape of a section of a sphere. Field of view 26 may have a range 40 of approximately five feet. As shown in FIG. 4, IR sensor 24 may be disposed in the middle of a top row of holes of speaker 44.

Speaker 44 may be capable of producing audible tones and audible spoken words that are intended to be heard by a user of security system 10. The content of the audio communications may be transmitted by control panel 20 to user interface 18 for broadcast by speaker 44.

Display 46 may include twelve segments 54a-1 arranged in a circle, a lock icon 56, and a person icon 58. Each of segments 54 is individually selectively displayable. Lock icon 56 may be selectively displayable. More particularly, lock icon 56 may be displayed as shown when security system 10 is armed, and may not be displayed when security system 10 is not armed. Person icon 58 may be displayed as shown within the circle formed by segments 54 when system 10 is armed in the Stay mode (building 12 is occupied); may be displayed outside the circle in area 60 when system 10 is armed in the Away mode (building 12 is unoccupied); and may not be displayed at all when system 10 is not armed.

Keypad 48 may include pushbuttons 64a-f. Pushbuttons 64a-e correspond to numbers 1-5, respectively, and may be depressed by the user to thereby enter a passcode having multiple digits. As an alternative to entering a passcode, a user may wave a token 38 by user interface 18 in order to identify himself as an approved user of security system 10. Pushbutton 64e may be used by the user, e.g., may be depressed multiple times, to set a volume level of the sounds produced by speaker 44. Pushbutton 64f may be depressed by the user in order to cause speaker 44 and/or display 46 to respectively produce audible and visible information and/or instructions for the benefit of the user.

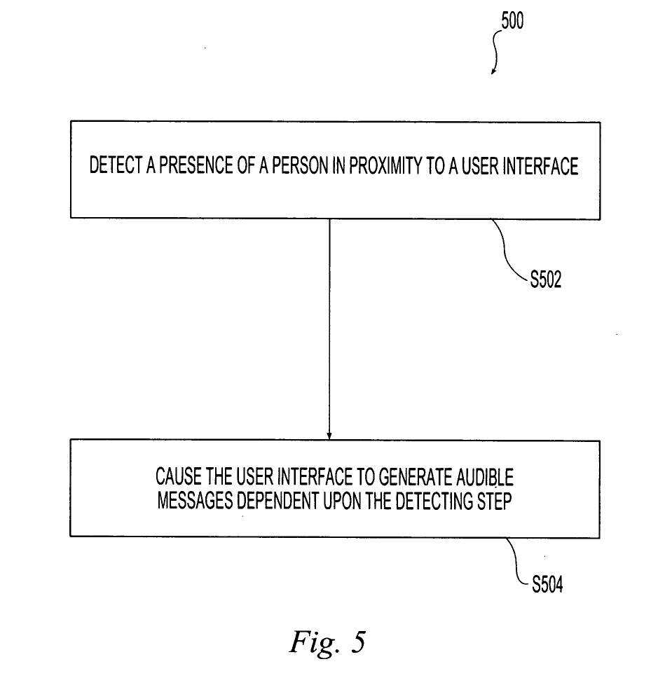

One embodiment of a method 500 of the present invention for operating security system 10 is illustrated in FIG. 5. In a first step S502, a presence of a person in proximity to a user interface is detected. For example, IR sensor 24 may detect the presence of a person who is disposed within field of view 26, i.e., in proximity to user interface 18.

In a next step S504, the user interface is caused to generate audible messages dependent upon the detecting step S502. For example, user interface 18 may generate different audible messages depending upon whether IR sensor 24 has detected the presence of a person in proximity to user interface 18. More particularly, control panel 20 may receive a detection signal from IR sensor 24 indicating that a person is within field of view 26. In response to the detection of the person within field of view 26, i.e., someone positioned to operate user interface 18, control panel 20 may cause speaker 44 to broadcast audible voice messages that are related to security system 10. For example, the messages may be related to an arming state (Stay mode or Away mode; which of sensors 16 are activated; etc.) of security system 10, or may inform the user that security system 10 has a battery that is low on energy and needs to be replaced.

Control panel 20 may cause audio speaker 44 to generate audio messages of a first type only when a user's presence is detected near user interface 18, and to generate audio messages of a second type regardless of whether a user's presence is detected near user interface 18. The first type of message may be related to general information that is not especially urgent or important. For example, the first type of messages may include messages related to the arming state or battery condition of security system 10. The second type of message may include information that is more critical, time sensitive, and/or safety related. For example, the second type of messages may include information that smoke or a fire has been detected by sensors 16, or that sensors 16 have detected the presence of a possible intruder.

In addition to controlling the audio messages broadcast by speaker 44, control panel 20 may also issue an alarm signal in response to one or more of sensors 16 detecting a predefined event without a user thereafter entering a passcode or presenting a token 38 adjacent to user interface 18. The predefined event may include the presence of fire, smoke or gas, a door or window of building 12 opening, movement within building 12, or any other possible security breach that one of sensors 16 is designed to detect. The issuance of the alarm signal by control panel 20 may be performed independent of the detection of a person in proximity to user interface 18. That is, the issuance of an alarm signal by control panel 20 in response to a detection by a sensor 16 may occur regardless of the output of IR presence sensor 24. The issuance of the alarm signal may be of such importance that it needs to take place regardless of whether a user is standing in front of user interface 18. Moreover, it is possible that an intruder who caused the issuance of the alarm signal may be standing in front of user interface 18 and may be attempting to disarm security system 10.

The security system of the present invention has been illustrated herein as including a single user interface 18 that selectively broadcasts audio messages depending upon whether the presence of a user has been sensed in front of the user interface. However, in another embodiment, a security system of the present invention includes multiple user interfaces. In this embodiment, the control panel may cause the non-urgent audio messages to be broadcast by only those user interfaces in front of which a user's presence is detected. That is, those user interfaces that do not detect the presence of a user in front of them may broadcast audio messages of a critical nature, but may not broadcast audio messages of lesser importance.

It may be possible for a user to choose, via keypad 48, modes of broadcasting audio messages that are different than the embodiments described above. For example, the user may choose to override presence detector 24 to thereby cause all types of audio messages to be broadcast, regardless of whether the presence of a user is detected. The user might also choose to override presence detector 24 in another way by causing only critical types of audio messages to be broadcast, and inhibiting the broadcasting of less important messages regardless of whether the presence of a user is detected. It may also be possible for a user to choose, via keypad 48, the volume of the audio broadcast messages and/or the sensing range of the presence detector.

While this invention has been described as having an exemplary design, the present invention may be further modified within the spirit and scope of this disclosure. This application is therefore intended to cover any variations, uses, or adaptations of the invention using its general principles.

What is claimed is:

1. A method of operating a security system, said method comprising the steps of:
detecting a presence of a person in proximity to a user interface; and
causing said user interface to generate audible messages dependent upon said detecting step.

2. The method of claim 1 comprising the further steps of:
sensing a predefined event; and
issuing an alarm signal dependent upon said sensing step and independent of said detecting step.

3. The method of claim 1 wherein said causing step includes:
causing said user interface to generate a first type of audible message only when the presence of the person in proximity to said user interface is detected: and
causing said user interface to generate a second type of audible message regardless of whether the presence of the person in proximity to said user interface is detected.

4. The method of claim 3 wherein the second type of audible message includes audible messages related to at least one of an intruder and a fire sensed by said security system.

5. The method of claim 1 wherein said user interface includes an infrared sensor, said detecting step being performed by said infrared sensor.

6. The method of claim 1 wherein said user interface includes a visual display.

7. The method of claim 1 wherein said user interface includes a keypad.

8. The method of claim 1 wherein said audible messages are related to said security system.

9. A security system comprising:
a first sensor configured to detect a predefined event;
a user interface including:
an audio speaker; and
a second sensor configured to detect a presence of a person in proximity to said user interface; and
a control device in communication with said first sensor and said user interface, said control device being configured to:
issue an alarm signal in response to said first sensor detecting the predefined event; and
cause said audio speaker to generate audible messages dependent upon whether said second sensor detects the presence of a person in proximity to said user interface.

10. The system of claim 9 wherein the issuance of the alarm signal by said control device is independent of the detection of a person in proximity to said user interface.

11. The system of claim 9 wherein the audible messages are related to said security system.

12. The system of claim 9 wherein said control device is configured to:
cause said audio speaker to generate a first type of audible message only when the presence of the person in proximity to said user interface is detected; and
cause said audio speaker to generate a second type of audible message regardless of whether the presence of the person in proximity to said user interface is detected.

13. The system of claim 12 wherein the second type of audible message includes audible messages related to at least one of an intruder and a fire detected by said first sensor.

14. The system of claim 9 wherein said second sensor comprises an infrared sensor.

15. The system of claim 9 wherein said user interface includes a visual display.

16. The system of claim 9 wherein said user interface includes a keypad.

17. A security system comprising:
an audio speaker;
a sensor configured to detect a presence of a person in proximity to said audio speaker; and
a control device in communication with said sensor and said audio speaker, said control device being configured to:
cause said audio speaker to generate audible messages of a first type, the generation of the audible messages of the first type being dependent upon whether said sensor detects the presence of a person in proximity to said audio speaker; and
cause said audio speaker to generate audible messages of a second type regardless of whether said sensor detects the presence of a person in proximity to said audio speaker.

18. The system of claim 17 wherein the audible messages are related to said security system.

19. The system of claim 17 wherein the audible message of the second type includes audible messages related to at least one of an intruder and a fire detected by said security system.

20. The system of claim 17 wherein said sensor comprises an infrared sensor.
